(19) United States
(12) Patent Application Publication
(10) Pub. No.: US 2015/0196899 A1
(43) Pub. Date: Jul. 16, 2015

(54) EXHAUST GAS PURIFICATION CATALYST

(71) Applicant: TOYOTA JIDOSHA KABUSHIKI KAISHA, Toyota-shi (JP)

(72) Inventor: Rui IMOTO, Toyota-shi (JP)

(73) Assignee: TOYOTA JIDOSHA KABUSHIKI KAISHA, Toyota-shi (JP)

(21) Appl. No.: 14/588,666

(22) Filed: Jan. 2, 2015

(30) Foreign Application Priority Data
Jan. 15, 2014 (JP) 2014-005184

(51) Int. Cl. B01J 27/16; B01J 23/10; B01J 23/46; B01J 21/02; B01J 23/42

(52) U.S. Cl. CPC B01J 27/16; B01J 21/02; B01J 23/42; B01J 23/464; B01J 23/10

(57) ABSTRACT

An exhaust gas purification catalyst includes: a substrate; a first catalyst layer that is arranged on an upper surface of the substrate and contains a first support and platinum supported on the first support, in which the first support contains a composite oxide which is formed of oxygen and at least one element selected from the group consisting of aluminum, phosphorus and boron and has an oxygen 1s binding energy in a range of 530 eV to 535 eV; and a second catalyst layer that is arranged on an upper surface of the first catalyst layer and contains a second support and rhodium supported on the second support, in which the second support contains a less-thermally-deteriorative ceria-zirconia composite oxide or a porous alumina.

### INCORPORATION BY REFERENCE

The disclosure of Japanese Patent Application No. 2014-005184 filed on Jan. 15, 2014 including the specification, drawings and abstract is incorporated herein by reference in its entirety.

### BACKGROUND OF THE INVENTION

1. Field of the Invention

The present invention relates to an exhaust gas purification catalyst.

2. Description of Related Art

An exhaust gas purification catalyst of an automobile causes hydrocarbon (HC) and carbon monooxide (CO) to be oxidized into water and carbon dioxide and causes nitrogen oxide (NOₓ) to be reduced into nitrogen, in which hydrocarbon (HC), carbon monooxide (CO), and nitrogen oxide (NOₓ) are contained in exhaust gas exhausted from an engine. As the exhaust gas purification catalyst (hereinafter, also referred to as “three way catalyst”) having such catalytic activity, a noble metal-supported catalyst in which a catalyst layer containing particles of catalytic noble metals such as palladium (Pd), rhodium (Rh), and platinum (Pt) is coated on a heat-resistant substrate is commonly used. Typically, the catalyst layer of the noble metal-supported catalyst contains an OSC material having oxygen storage capacity (hereinafter, also referred as “OSC”) as a support or a co-catalyst in addition to the above-described catalytic noble metal particles. The OSC material stores and releases oxygen to promote an exhaust gas purification reaction by the catalytic noble metals. As the OSC material, a ceria (CeO₂)-zirconia (ZrO₂) composite oxide is widely used.

Typically, in order to avoid a decrease in catalytic activity by a component in exhaust gas such as sulfur, the catalyst layer of the exhaust gas purification catalyst has a configuration (hereinafter, also referred to as “layered catalyst”) in which plural catalyst layers are laminated on a substrate.

For example, Japanese Patent Application Publication No. 2004-298813 (JP 2004-298813 A) discloses a layered catalyst including: a support that is formed of a ceramic or a metal material; a first catalyst layer that is formed on the support; and a second catalyst layer that is formed on the first catalyst layer, in which the first catalyst layer is formed of a composite ceramic containing a platinum-supported alumina, in which a platinum component is supported on a porous alumina, and an oxygen-storing ceria-zirconia composite oxide, and the second catalyst layer is formed of a composite ceramic containing at least one of a rhodium-supported ceria-zirconia composite oxide and a rhodium-supported alumina, in which a rhodium component is supported on a less-thermally-deteriorative ceria-zirconia composite oxide or a porous alumina, and at least one of a porous alumina and a less-thermally-deteriorative ceria-zirconia composite oxide.

Japanese Patent Application Publication No. 2002-361089 (JP 2002-361089 A) discloses an exhaust gas purification catalyst in which a catalyst layer is coated on an integral structure type support having a polygonal cell cross-section through an undercoat layer formed of an inorganic oxide. JP 2002-361089 A describes that the catalyst layer may have a configuration in which a first catalyst layer containing only platinum as a catalytically active component and a second catalyst layer containing platinum and rhodium as catalytically active components are sequentially coated on the support. In addition, JP 2002-361089 A describes that it is preferable that platinum of the first catalyst layer be supported on a support material containing alumina as a major component and a support material containing a cerium oxide as a major component and that the amount of platinum supported on the support material containing alumina as a major component account for 30% to 80% of the total amount of platinum of the first catalyst layer.

As described above, the layered catalyst used for the exhaust gas purification catalyst is known. However, when such a layered catalyst is used over a long period of time, the catalytic activity may decrease due to the alloying of a catalytic noble metal caused by thermal diffusion of the catalytic noble metal in a catalyst layer and/or poisoning of a component in exhaust gas such as sulfur. In addition, sulfur in exhaust gas accumulates on a catalyst layer and is released as hydrogen sulfide, which may produces an abnormal odor.

### SUMMARY OF THE INVENTION

The invention has been made to provide an exhaust gas purification catalyst capable of substantially inhibiting a decrease in catalytic activity and/or the production of an abnormal odor after being used over a long period of time.

The present inventors have found that, in an exhaust gas purification catalyst, a decrease in catalytic activity and/or the production of an abnormal odor after being used over a long period of time can be substantially inhibited by laminating a first catalyst layer and a second catalyst layer on a substrate, in which the first catalyst layer contains platinum supported on a first support that contains a composite oxide formed of a specific element, and the second catalyst layer is arranged on an upper surface of the first catalyst layer and contains rhodium supported on a second support. Based on the above finding, the present inventors have completed the invention.

An aspect of the invention relates to an exhaust gas purification catalyst. The exhaust gas purification catalyst includes: a substrate; a first catalyst layer that is arranged on an upper surface of the substrate and contains a first support and platinum supported on the first support, in which the first support contains a composite oxide which is formed of oxygen and at least one element selected from the group consisting of aluminum, phosphorus and boron and has an oxygen 1s binding energy in a range of 530 eV to 535 eV; and a second catalyst layer that is arranged on an upper surface of the first catalyst layer and contains a second support and rhodium supported on the second support, in which the second support contains a less-thermally-deteriorative ceria-zirconia composite oxide or a porous alumina.

The first support of the first catalyst layer may contain aluminum phosphate or aluminum borate.

A coating weight of the first catalyst layer may be within a range of 40 g/L substrate to 150 g/L substrate, and a coating weight of the second catalyst layer may be within a range of 30 g/L substrate to 180 g/L substrate.

The thickness of the first catalyst layer may be within a range of 10 μm to 100 μm, and the thickness of the second catalyst layer may be within a range of 10 μm to 60 μm.

According to the invention, it is possible to provide an exhaust gas purification catalyst capable of substantially inhibiting a decrease in catalytic activity and/or the production of an abnormal odor after being used over a long period of time.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram illustrating a configuration of an exhaust gas purification catalyst according to an embodiment of the invention;

FIG. 2 is a schematic diagram illustrating temperature control conditions of a heat resistance treatment;

FIG. 3 is a schematic diagram illustrating temperature control conditions of a sulfur poisoning treatment;

FIG. 4 is a schematic diagram illustrating temperature control conditions of a catalytic activity evaluation test;

FIG. 5 is a diagram illustrating a relationship between O 1s binding energies of catalysts of Comparative Examples 1 to 3 and Examples 1 and 2 and a NOₓ 50% purification temperature;

FIG. 6 is a diagram illustrating a relationship between O 1s binding energies of catalysts of Comparative Examples 1 to 3 and Examples 1 and 2 and the amount of accumulated sulfur; and

FIG. 7 is diagram illustrating a scanning electron microscope (SEM) image of a cross-section of a catalyst of Example 1.

### DETAILED DESCRIPTION OF EMBODIMENTS

Hereinafter, preferred embodiments of the invention will be described in detail.

In this specification, characteristics of the invention will be described while appropriately referring to the drawings. In the drawings, the dimension and shape of each portion are illustrated with exaggeration for the sake of clarity and are not exactly the same as the actual dimension and shape thereof. Accordingly, the technical scope of the invention is not particularly limited to the dimension and shape of each portion illustrated in the drawings.

<1. Exhaust Gas Purification Catalyst>

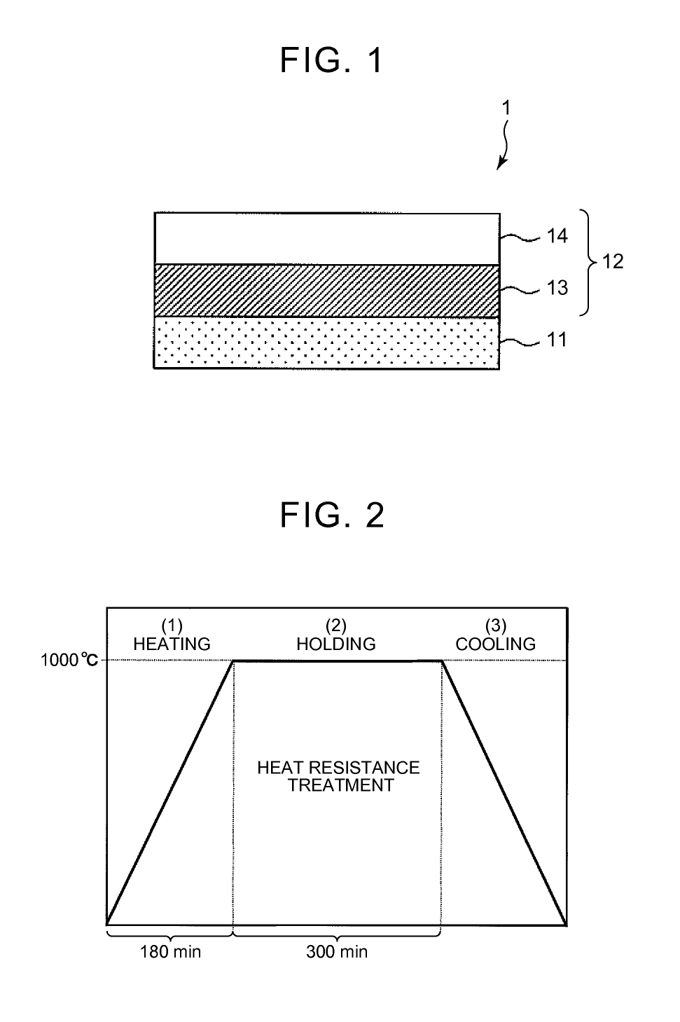

FIG. 1 is a schematic diagram illustrating a configuration of an exhaust gas purification catalyst 1 according to an embodiment of the invention. As illustrated in FIG. 1, the exhaust gas purification catalyst 1 includes a substrate 11 and a catalyst layer 12 that is arranged on the substrate 11. Further, the catalyst layer 12 includes a first catalyst layer 13 that is arranged on the substrate 11 and a second catalyst layer 14 that is arranged on an upper surface of the first catalyst layer 13.

The present inventors have found that, in an exhaust gas purification catalyst having a configuration of a layered catalyst (also referred to as “two-layer catalyst”) including a first catalyst layer and a second catalyst layer as described above, a decrease in catalytic activity and/or the production of an abnormal odor after being used over a long period of time can be substantially inhibited by using a composite oxide formed of a specific element as a material of a support used in the first catalyst layer. The reason why the exhaust gas purification catalyst 1 has the above-described characteristics can be described as follows. The invention is not particularly limited to the following action and principle.

In a gasoline engine used as the power of an automobile, the temperature of exhaust gas is high. Therefore, high heat resistance is required for an exhaust gas purification catalyst for an automobile. It was found that, when high-temperature exhaust gas circulates around the exhaust gas purification catalyst, the sintering of a catalytic noble metal which is a catalytic site occurs due to an interaction between the exhaust gas and the catalytic noble metal, and particles of the catalytic noble metal are coarsened. In this way, when the sintering of a catalytic noble metal occurs, the catalytic activity may decrease. In order to inhibit the sintering of a catalytic noble metal, it is advantageous that a high-basicity compound having high ability to absorb a metal atom be used as a support material contained in a catalyst layer.

In the case of the two-layer catalyst, it was found that a catalytic noble metal of the second catalyst layer (upper layer) is thermally diffused and forms an alloy with a catalytic noble metal of the first catalyst layer (lower layer). It is considered that this phenomenon occurs because the catalytic noble metal of the second catalyst layer (upper layer) is attracted due to the basicity of a compound of a support material contained in the first catalyst layer (lower layer). In this way, when the catalytic noble metals are alloyed, the catalytic activity may significantly decrease or be lost. In order to inhibit the alloying of the catalytic noble metals, it is advantageous that a low-basicity compound having low ability to attract a metal atom be used as the support material contained in the first catalyst layer (lower layer).

It is known that a sulfur component (for example, an acidic gas such as SOₓ) contained in gasoline fuel is absorbed on a compound of a support material contained in a catalyst layer of an exhaust gas purification catalyst and accumulates on the catalyst layer. SOₓ accumulated on the catalyst layer is reduced and is released as hydrogen sulfide (H₂S) which emits an abnormal odor when being stopped under a high load. This abnormal odor becomes an exhaust gas odor. Therefore, it is required to inhibit the accumulation of sulfur in a compound of a support material contained in a catalyst layer of an exhaust gas purification catalyst for an automobile. In order to inhibit the accumulation of sulfur on a catalyst layer, it is advantageous that a low-basicity compound having low ability to absorb SOₓ be used as a support material contained in a catalyst layer. In addition, in the case of the two-layer catalyst, a compound of a support material of the first catalyst layer (lower layer) having higher catalytic activity, on which a catalytic noble metal of the first catalyst layer is supported, largely contributes to the production of an abnormal odor by the accumulation of sulfur. Accordingly, in the case of the two-layer catalyst, it is advantageous that a low-basicity compound having low ability to absorb SOₓ be used as a support material contained in the first catalyst layer (lower layer).

As described above, in order to satisfy all the requirements including the inhibition of the sintering of a catalytic noble metal, the inhibition of the alloying of a catalytic noble metal, and the inhibition of the accumulation of sulfur, it is necessary to select a support material of a catalyst layer having the optimum basicity. Accordingly, it is extremely difficult to select the support material of a catalyst layer having the optimum basicity and thereby to obtain an exhaust gas purification catalyst having high heat resistance.

The present inventors have found that, in an exhaust gas purification catalyst having the configuration of the two-layer catalyst, all the requirements including the inhibition of the sintering of a catalytic noble metal, the inhibition of the alloying of a catalytic noble metal, and the inhibition of the accumulation of sulfur can be satisfied by selecting, as a support material contained in the first catalyst layer (lower layer), a composite oxide formed of oxygen and at least one element selected from the group consisting of aluminum, phosphorus, and boron, in which a 1s orbital binding energy of an oxygen atom (hereinafter, also referred to as “oxygen 1s binding energy” or “O 1s binding energy) in the composite oxide is within a range of 530 eV to 535 eV. Since the above-described composite oxide has a small number of basic groups on a surface thereof, the ability to absorb SOₓ and the ability to attract a catalytic noble metal of the second catalyst layer (upper layer) are low. Therefore, in the exhaust gas purification catalyst 1 in which the first catalyst layer contains the above-described support material, the accumulation of sulfur and the alloying of a catalytic noble metal can be substantially inhibited. On the other hand, the above-described composite oxide has a high O 1s binding energy. This is because the composite oxide has a strong covalent bond between oxygen, and phosphorus and boron. Due to this property, the above-described composite oxide can form an interaction, which is similar to a basic compound, with a catalytic noble metal. Therefore, in the exhaust gas purification catalyst 1 in which the first catalyst layer contains the above-described support material, the sintering of a catalytic noble metal can be substantially inhibited.

In the exhaust gas purification catalyst 1, the first catalyst layer 13 contains a support that contains the composite oxide formed of oxygen and at least one element selected from the group consisting of aluminum, phosphorus, and boron. The composite oxide is used as an OSC material of the first catalyst layer 13. The composite oxide contained in the support is preferably an aluminum salt of an oxo acid such as phosphoric acid or boric acid, more preferably aluminum phosphate or aluminum borate, and still more preferably aluminum phosphate represented by AlPO₄ or aluminum borate represented by 9Al₂O₃-2B₂O₃. The above-described aluminum salt of an oxo acid has low surface basicity. The low-basicity compound may decrease an interaction with a metal atom. In addition, the low-basicity compound has a low ability to absorb an acidic gas such as a sulfur component (for example, SOₓ) contained in gasoline fuel. Accordingly, when the support of the first catalyst layer contains the composite oxide which is the above-described aluminum salt of an oxo acid, an interaction with rhodium which is the catalytic noble metal supported on the second catalyst layer is substantially inhibited, and a decrease in catalytic activity caused by the thermal diffusion and alloying of rhodium can be substantially inhibited. In addition, the accumulation of sulfur contained in gasoline fuel can be substantially inhibited.

The composite oxide contained in the support of the first catalyst layer 13 has an O 1s binding energy in a range of 530 eV to 535 eV. The O 1s binding energy of the composite oxide is preferably within a range of 532 eV to 535 eV. By using the composite oxide having an O 1s binding energy within the above-described range as the support material of the first catalyst layer, the sintering of a catalytic noble metal can be substantially inhibited.

The O 1s binding energy of the composite oxide can be determined by irradiating the first catalyst layer or a surface of a material thereof with X-rays, for example, according to JIS K 0147 using an X-ray photoelectron spectrometer (XPS; Al radiation source) to analyze an electronic state of the first catalyst layer or the surface of the material thereof.

The first catalyst layer 13 contains platinum as a catalytic noble metal supported on the support. The platinum content is preferably within a range of 0.01 mass % to 2 mass % and more preferably within a range of 0.1 mass % to 1 mass % with respect to the total mass of the first catalyst layer. Within the above-described platinum content range, high exhaust gas purification performance can be exhibited.

In the exhaust gas purification catalyst 1, the second catalyst layer 14 contains a support that contains a less-thermally-deteriorative ceria-zirconia composite oxide or a porous alumina. The less-thermally-deteriorative ceria-zirconia composite oxide and the porous alumina are used as OSC materials of the second catalyst layer 14. In the invention, “ceria-zirconia composite oxide” refers to a composite oxide containing ceria (CeO₂) and zirconia (ZrO₂). In the invention, “less-thermally-deteriorative” or “thermal deterioration being low” typically refers to oxygen storage capacity (OSC) not substantially decreasing in a range of 400° C. to 700° C. In addition, in the invention, “porous” typically refers to a pore size measured using a pore distribution method (gas absorption method or mercury intrusion method) being within a range of 0.4 nm to 100 μm. The less-thermally-deteriorative ceria-zirconia composite oxide contains, for example, preferably 20 mass % to 60 mass % of CeO₂ and 40 mass % to 80 mass % of ZrO₂ with respect to the total mass of the composite oxide. In addition, in the composite oxide, a mass ratio of CeO₂ to ZrO₂ is preferably within a range of 1:0.67 to 1:4 and more preferably within a range of 1:1 to 1:4. The porous alumina is preferably γ-alumina or θ-alumina. By using the above-described support material, the heat resistance of the exhaust gas purification catalyst 1 can be further improved.

The second catalyst layer 14 contains rhodium as a catalytic noble metal supported on the support. The rhodium content is preferably within a range of 0.01 mass % to 1 mass % and more preferably within a range of 0.05 mass % to 0.5 mass % with respect to the total mass of the second catalyst layer. Within the above-described rhodium content range, high exhaust gas purification performance can be exhibited.

In the exhaust gas purification catalyst 1, the coating weight of the first catalyst layer 13 is preferably within a range of 40 g/L substrate to 150 g/L substrate and more preferably within a range of 50 g/L substrate to 120 g/L substrate. The coating weight of the second catalyst layer 14 is preferably within a range of 30 g/L substrate to 180 g/L substrate and more preferably within a range of 50 g/L substrate to 100 g/L substrate. In addition, a mass ratio of the coating weight of the first catalyst layer 13 to the coating weight of the second catalyst layer 14 is preferably within a range of 1:0.6 to 1:1.2 and more preferably within a range of 1:0.65 to 1:1. By the exhaust gas purification catalyst containing the first and second catalyst layers with the above-described coating weights, a decrease in catalytic activity by a component in exhaust gas such as sulfur can be substantially avoided, and high exhaust gas purification performance can be exhibited after an automobile is driven over a long period of time.

The coating weights of the first catalyst layer and the second catalyst layer are not particularly limited and may be determined using a method of dissolving each of the catalyst layers in an acid or the like and performing inductively coupled plasma (ICP) emission spectroscopy on a metal component in the solution.

In the exhaust gas purification catalyst 1, the thickness of the first catalyst layer 13 is preferably within a range of 10 μm to 100 μm, more preferably within a range of 10 μm to 80 μm, and still more preferably within a range of 15 μm to 75 μm. The thickness of the second catalyst layer 14 is preferably within a range of 10 μm to 60 μm, more preferably within a range of 10 μm to 50 μm, and still more preferably within a range of 15 μm to 45 μm. In addition, a ratio of the thickness of the first catalyst layer 13 to the thickness of the second catalyst layer 14 is preferably within a range of 1:1 to 2:1, more preferably within a range of 1:1 to 1.6:1, and still more preferably within a range of 1.1:1 to 1.5:1. By the exhaust gas purification catalyst containing the first and second catalyst layers with the above-described thicknesses, a decrease in catalytic activity by a component in exhaust gas such as sulfur can be substantially avoided, and high exhaust gas purification performance can be exhibited after an automobile is driven over a long period of time.

The thicknesses of the first catalyst layer and the second catalyst layer are not particularly limited and may be determined using a method of observing a cross-section of the catalyst with a scanning electron microscope (SEM) and calculating the average of the thicknesses of predetermined positions of the catalyst layer or using electron probe microanalysis (EPMA).

In the exhaust gas purification catalyst 1, optionally, the first catalyst layer 13 and the second catalyst layer 14 may further contain one or more additional materials. Regarding the additional materials, for example, it is preferable that, as in the case of the second catalyst layer, the ceria-zirconia composite oxide be used as the material of the first catalyst layer. By the first catalyst layer and the second catalyst layer containing the additional materials, the exhaust gas purification performance and/or the oxygen storage capacity of the exhaust gas purification catalyst 1 can be further improved.

The composition of each material contained in the first catalyst layer and the second catalyst layer is not particularly limited and may be determined using a method, for example, a method of dissolving each of the catalyst layers in an acid or the like and performing inductively coupled plasma (ICP) emission spectroscopy on a metal component in the solution, a method of performing energy-dispersive X-ray (EDX) spectroscopy or electron probe microanalysis (EPMA) on a cross-section or a surface of each of the catalyst layers, or a method of performing X-ray fluorescence analysis (XRF) on powder of each of the catalyst layers.

In the exhaust gas purification catalyst 1, the substrate 11 is preferably in the form of a honeycomb, a pellet, or particles and is more preferably a monolith substrate having the form of a honeycomb. In addition, it is preferable that the substrate 11 contain a heat-resistant inorganic material such as cordierite or metal. By using the substrate having the above-described characteristics, the catalytic activity of the exhaust gas purification catalyst can be maintained under a high-temperature condition.

The exhaust gas purification catalyst 1 can be manufactured using a method which is commonly used in the related art such as a method of sequentially wash-coating a catalyst layer material slurry containing a support material and, optionally, a catalytic noble metal on the substrate. A method of manufacturing the exhaust gas purification catalyst 1 is not limited to these methods.

In the exhaust gas purification catalyst 1, the accumulation of sulfur, which is contained in fuel, on the catalyst layers (particularly, the first catalyst layer) can be substantially inhibited. It is generally known that the amount of sulfur accumulated on the catalyst layers contained in the exhaust gas purification catalyst has a correlation with an exhaust gas odor (the major component is H₂S) produced when the catalyst is used for purifying exhaust gas of an automobile. Accordingly, the exhaust gas purification catalyst 1 is preferably used for purifying exhaust gas of an automobile and is more preferably used as an underfloor catalyst in an automobile. By using the exhaust gas purification catalyst 1 for the above-described applications, the production of an exhaust gas odor can be substantially inhibited.

As described above, in the exhaust gas purification catalyst 1, the thermal diffusion of rhodium used as the catalytic noble metal of the second catalyst layer can be substantially inhibited, the accumulation of sulfur in fuel can be substantially inhibited, and thus a decrease in catalytic activity and/or the production of an abnormal odor after being used over a long period of time can be substantially inhibited. Accordingly, by using this exhaust gas purification catalyst 1 for purifying exhaust gas of an automobile, high exhaust gas purification performance can be exhibited and/or the production of an exhaust gas odor can be substantially inhibited after the automobile is driven over a long period of time.

Hereinafter, the invention will be described in more detail using Examples. However, the technical scope of the invention is not limited to these Examples.

<I. Material>

### [I-1. Preparation of Aluminum Phosphate]

150 ml of ion exchange water was poured into a beaker, and a stirring bar was put thereinto. 0.1 mol of aluminum nitrate nonahydrate (manufactured by Nacalai Tesque Inc.) was added to the ion exchange water and was stirred to be dissolved therein. 85 mass % of phosphoric acid (manufactured by Nacalai Tesque Inc.) was weighed and put into another beaker in an amount corresponding to 0.1 mol of phosphoric acid. The weighed phosphoric acid was added to the aqueous aluminum nitrate solution under stirring. The phosphoric acid remaining in the beaker was washed and recovered with ion exchange water and then was added to the aqueous mixed solution. 28% ammonia water (manufactured by Nacalai Tesque Inc.) was added dropwise little by little to the obtained aqueous mixed solution using a pipette such that pH was 4.0. Next, a cover was placed on the beaker of the aqueous mixed solution, followed by stirring at room temperature for 12 hours. Next, the aqueous mixed solution was centrifuged (3000 rpm, 10 minutes) to be separated into a precipitate and a supernatant. An appropriate amount of ion exchange water was added to the obtained precipitate, and the mixture was suspended, followed by centrifugal separation under the same conditions as above to be separated into a precipitate and a supernatant. The obtained precipitate was dried using a drying machine at 120° C. for 12 hours. The obtained dry substance was crushed into powder using a mortar and a pestle. This powder was fired in an electric furnace at 1100° C. for 5 hours to obtain aluminum phosphate.

### [I-2. Preparation of First Catalyst Layer Material]

150 ml of ion exchange water was poured into a beaker, and a stirring bar was put thereinto. A predetermined amount of aqueous platinum nitrate solution (concentration: 8.6 mass %; used amount: 9.5 g) was added to this ion exchange water, followed by stirring. 40 g of a support material shown below was weighed and added to this aqueous solution, followed by stirring. The obtained aqueous solution was heated to 150° C. under stirring to evaporate water. The residual substance was dried using a drying machine at 120° C. for 12 hours. The obtained dry substance was crushed into powder using a mortar and a pestle. This powder was fired in an electric furnace at 500° C. for 3 hours to obtain a first catalyst layer material.

TABLE 1

| Experimental Plot | Material |
|---|---|
| Example 1 | Aluminum Borate |
| | (9Al₂O₃—2B₂O₃) |
| Example 2 | Aluminum Phosphate |
| | (AlPO₄) |
| Comparative Example 1 | Nanotek Silica |
| | (SiO₂) |
| Comparative Example 2 | Lanthanum-Added Alumina |
| | (La—Al₂O₃) |
| Comparative Example 3 | Ceria-Zirconia Composite Oxide |
| | (CeO₂—ZrO₂) |

### [I-3. Preparation of Second Catalyst Layer Material]

100 ml of ion exchange water was poured into a beaker, and a stirring bar was put thereinto. A predetermined amount of aqueous rhodium nitrate solution (concentration: 2.75 mass %; used amount: 2.86 g) was added to this ion exchange water, followed by stirring. 15 g of a porous alumina (lanthanum-added alumina) and 15 g of a less-thermally-deteriorative ceria-zirconia composite oxide were weighed and added to the aqueous solution, followed by stirring. The obtained aqueous solution was heated to 150° C. under stirring to evaporate water. The residual substance was dried using a drying machine at 120° C. for 12 hours. The obtained dry substance was crushed into powder using a mortar and a pestle. This powder was fired in an electric furnace at 500° C. for 3 hours to obtain a second catalyst layer material.

<II. Preparation of Catalyst>

### [II-1. Preparation of First Catalyst Layer]

3.82 g of the first catalyst layer material and 0.08 g of an alumina-based binder were added to ion exchange water, followed by milling overnight under stirring. Next, the viscosity of the obtained mixture was adjusted to obtain a slurry. The slurry was poured onto a 35 mL (L=50 mm) test piece substrate having a ceramic honeycomb structure to coat an inner wall surface of the substrate with the slurry. The substrate coated with the slurry was left to stand in a drying machine set at 150° C. for 1 hour to evaporate water of the slurry. Next, the substrate was left to stand in an electric furnace set at 500° C. for 3 hours to fire the substrate and the coating. As a result, a first catalyst layer (total coating weight: 3.89 g; 111.1 g/L substrate) was prepared.

### [II-2. Preparation of Second Catalyst Layer]

Using 2.40 g of the second catalyst layer material and 0.16 g of an alumina-based binder, a slurry containing the second catalyst layer material was prepared according to the same procedure as in the above-described II-1. The obtained slurry was poured onto the substrate on which the first catalyst layer was formed to coat an upper surface of the first catalyst layer with the slurry. The substrate coated with the slurry was left to stand in a drying machine set at 250° C. for 1 hour to evaporate water of the slurry. Next, the substrate was left to stand in an electric furnace set at 500° C. for 3 hours to fire the substrate and the coating. As a result, a second catalyst layer (total coating weight: 2.56 g; 73.1 g/L substrate) was prepared.

<III. Evaluation Method of Catalyst>

### [III-1. X-Ray Photoelectron Spectrometry]

Surfaces of the first catalyst layer materials used in catalysts of Comparative Examples 1 to 3 and Examples 1 and 2 were irradiated with X-rays according to JIS K 0147 using an X-ray photoelectron spectrometer (XPS; Al radiation source; PHI 5000; manufactured by Philips) to analyze an electronic state of the surface of the first catalyst layer material. An O 1s binding energy (eV) was determined from the obtained XPS spectrum.

### [III-2. Heat Resistance Treatment]

Using a gasoline engine, a heat resistance treatment was performed on the catalysts of Comparative Examples 1 to 3 and Examples 1 and 2 under temperature conditions illustrated in FIG. 2. Here, the gas flow rate was fixed to 10 L/min. The gas composition was set to obtain a partial pressure of N₂=100% in (1) heating process and (3) cooling process and partial pressures of CO/O₂/H₂O/N₂=1/5/10/balance in (2) holding process, and the circulation of either CO gas or O₂ gas was stopped at intervals of 5 minutes. As a result, the deterioration of the catalysts was accelerated while changing the composition of exhaust gas.

### [III-3. Sulfur Poisoning Treatment]

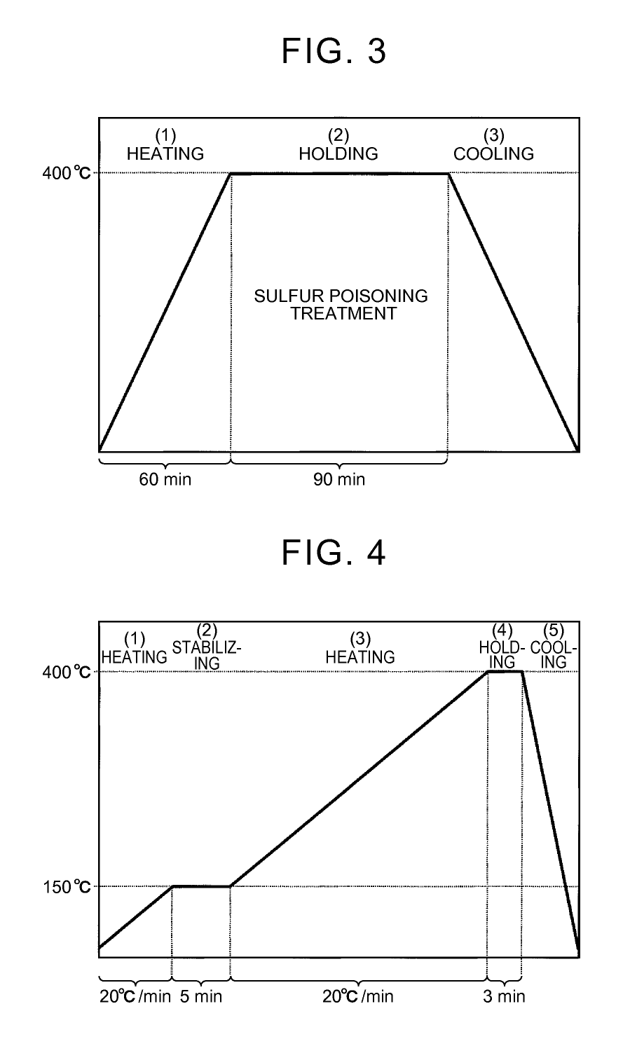

Using a gasoline engine, a sulfur poisoning treatment was performed on the first catalyst layer materials of the catalysts of Comparative Examples 1 to 3 and Examples 1 and 2 under temperature conditions illustrated in FIG. 3. As samples, 1 g of pellets formed from the first catalyst layer materials of the respective Comparative Examples and Examples were used. Here, the gas flow rate was fixed to 5 L/min. The gas composition was set to obtain a partial pressure of N₂=100% in (1) heating process and (3) cooling process and partial pressures of NO/CO/C₃H₆/CO₂/O₂/H₂O/SO₂/N₂=0.1/0.65/0.1/10/0.725/3/0.05/balance in (2) holding process. As a result, the deterioration of the catalysts was accelerated while changing the composition of exhaust gas.

### [III-4. Measurement of Amount of Accumulated Sulfur]

According to the procedure of the above-described III-3, a sulfur poisoning treatment was performed on the first catalyst layer materials of the catalysts of Comparative Examples 1 to 3 and Examples 1 and 2. The amount of accumulated sulfur contained in each of the samples (pellets) after the treatment was measured using a C-S analyzer (EMIA-820W, manufactured by Horiba Ltd.).

### [III-5. Catalytic Activity Evaluation Test]

According to the procedure of the above-described III-2, a heat resistance treatment was performed on the catalysts of Comparative Examples 1 to 3 and Examples 1 and 2. Using a model gas device, the activity of the catalysts of Comparative Examples 1 to 3 and Examples 1 and 2 after the heat resistance treatment was evaluated under temperature conditions illustrated in FIG. 4. Here, the gas flow rate was fixed to 30 L/min. The gas composition was set to obtain partial pressures of NO/CO/C₃H₆/CO₂/O₂/H₂O/N₂=0.19/0.95/0.15/9.5/0.41/4.73/balance. A NOₓ purification ratio was calculated from the following expression. In the following expression, an inflow gas concentration represents the NOₓ concentration in a gas inflow portion of a catalyst, and an outflow gas concentration represents the NOₓ concentration in a gas outflow portion of a catalyst.

NOₓ purification ratio (%)=(Inflow Gas Concentration−Outflow Gas Concentration)/(Inflow Gas Concentration)×100

Based on the above-described expression, a NOₓ purification ratio in (3) heating process was calculated, and a temperature at which 50% of NOₓ was purified was determined as a NOₓ 50% purification temperature (° C.).

### [III-6. Measurement of Thickness of Catalyst Layer]

Using a scanning electron microscope (SEM), cross-sections of the catalysts of Comparative Examples 1 to 3 and Examples 1 and 2 were observed. Regarding each of the cross-sections of the catalysts, the thicknesses of the first catalyst layer and the second catalyst layer formed on the surface of the substrate were measured at 25 positions of an inside corner portion and 36 positions of a linear portion of the substrate. Regarding each of the catalysts, the average values of the thicknesses of the catalyst layers at the inside corner portion and the linear portion of the substrate were calculated.

<IV. Evaluation Results of Catalyst>

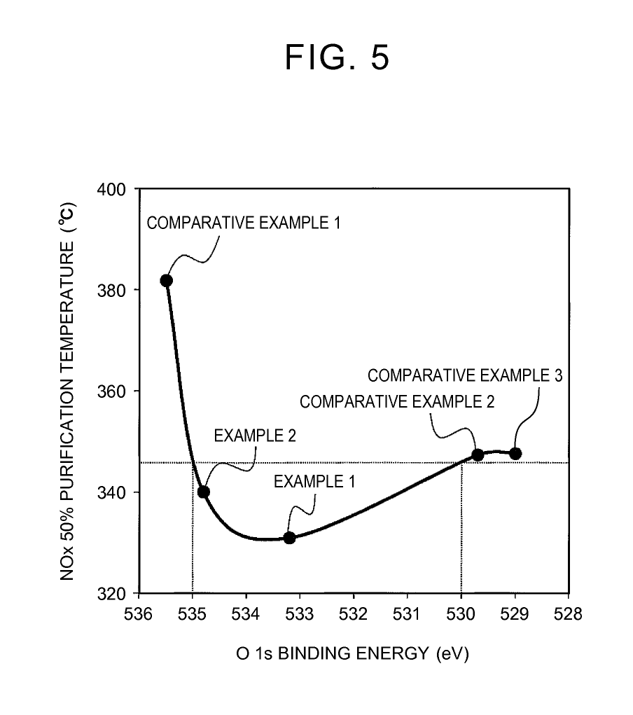

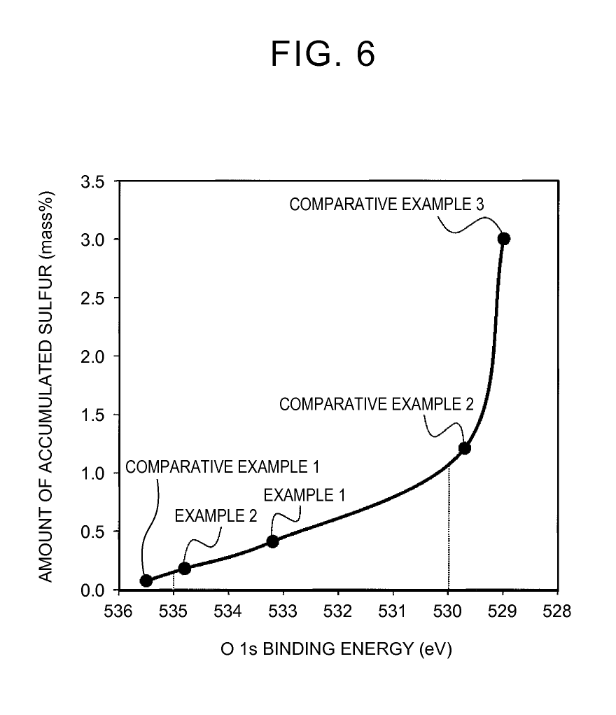

Regarding each of the catalysts of Comparative Examples 1 to 3 and Examples 1 and 2, the O 1s binding energy, the NOₓ 50% purification temperature, and the amount of accumulated sulfur were determined according to the above-described procedure. FIG. 5 illustrates a relationship between the O 1s binding energy and the NOₓ 50% purification temperature of each of the catalysts, and FIG. 6 illustrates a relationship between the O 1s binding energy and the amount of accumulated sulfur of each of the catalysts.

As illustrated in FIG. 5, in the catalyst of Comparative Example 1 in which the O 1s binding energy was higher than 535 eV, the NOₓ 50% purification temperature was higher than 380° C.; whereas, in the catalysts of Examples 1 and 2 in which the O 1s binding energy was 535 eV or lower, the NOₓ 50% purification temperature decreased significantly. However, in the catalysts of Comparative Examples 2 and 3 in which the O 1s binding energy was lower than 530 eV, the NOₓ 50% purification temperature increased again.

It is known that the amount of accumulated sulfur of each of the catalyst layer materials measured according to the procedure of the above-described III-4 has a correlation with an exhaust gas odor (the major component is H₂S) produced when the catalyst containing the catalyst layer material is used for purifying exhaust gas of an automobile. As illustrated in FIG. 6, in the catalysts of Comparative Examples 2 and 3 in which the O 1s binding energy was lower than 530 eV, the amount of accumulated sulfur was higher than 1 mass %; whereas, in the catalysts of Examples 1 and 2 and Comparative Example 1 in which the O 1s binding energy was 530 eV or higher, the amount of accumulated sulfur was 1 mass % or lower.

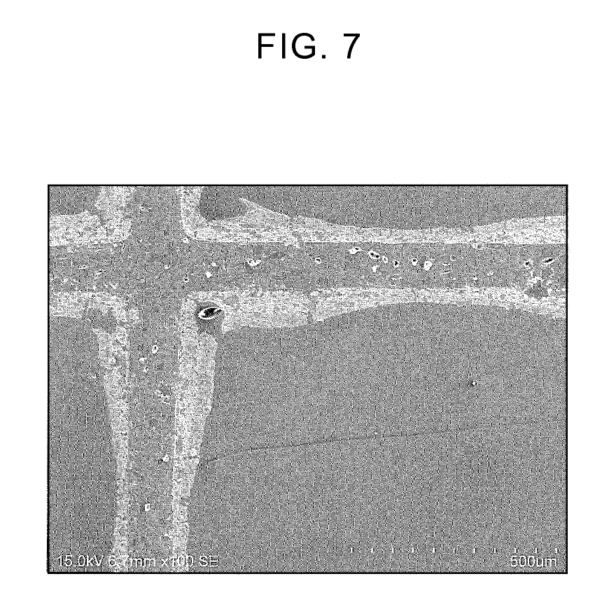

Regarding each of the catalysts of Comparative Examples 1 to 3 and Examples 1 and 2, the thicknesses of the first catalyst layer and the second catalyst layer were measured according to the above-described procedure. FIG. 7 illustrates a scanning electron microscope (SEM) image of the cross-section of the catalyst of Example 1.

The thicknesses of the catalyst layers measured according to the procedure of the above-described III-6 were substantially the same in all the catalysts of Comparative Examples 1 to 3 and Examples 1 and 2. In the catalyst of Example 1, the thicknesses of the first catalyst layer and the second catalyst layer formed on the surface of the inner corner portion of the substrate were 70.4 μm and 46.8 μm, respectively. In addition, the thicknesses of the first catalyst layer and the second catalyst layer formed on the surface of the linear portion of the substrate were 18.1 μm and 16.0 μm, respectively.

What is claimed is:

1. An exhaust gas purification catalyst comprising:
a substrate;
a first catalyst layer that is arranged on an upper surface of the substrate and contains a first support and platinum supported on the first support, the first support containing a composite oxide which is formed of oxygen and at least one element selected from the group consisting of aluminum, phosphorus and boron and has an oxygen 1s binding energy in a range of 530 eV to 535 eV; and
a second catalyst layer that is arranged on an upper surface of the first catalyst layer and contains a second support and rhodium supported on the second support, the second support containing a less-thermally-deteriorative ceria-zirconia composite oxide or a porous alumina.

2. The exhaust gas purification catalyst according to claim 1, wherein
the first support of the first catalyst layer contains aluminum phosphate or aluminum borate.

3. The exhaust gas purification catalyst according to claim 1, wherein
a coating weight of the first catalyst layer is within a range of 40 g/L substrate to 150 g/L substrate, and
a coating weight of the second catalyst layer is within a range of 30 g/L substrate to 180 g/L substrate.

4. The exhaust gas purification catalyst according to claim 1, wherein
a thickness of the first catalyst layer is within a range of 10 μm to 100 μm, and
a thickness of the second catalyst layer is within a range of 10 μm to 60 μm.
